(19) United States
(12) Patent Application Publication
(10) Pub. No.: US 2015/0212631 A1
(43) Pub. Date: Jul. 30, 2015

(54) SYSTEM, METHOD, AND COMPUTER PROGRAM PRODUCT FOR MULTIPLE STIMULUS SENSORS FOR AN INPUT DEVICE

(71) Applicant: NVIDIA Corporation, Santa Clara, CA (US)

(72) Inventors: Dhaval Sanjaykumar Dave, Ahmedabad (IN); Anup Ashok Dalvi, Pune (IN); Hardik Jagdishbhai Parekh, Rajkot (IN); Neel Kumarbhai Patel, Junagadh (IN); Sourabh Datta Kunden, Pune (IN); Trilok Chander Kunchakarra, Hyderabad (IN)

(73) Assignee: NVIDIA Corporation, Santa Clara, CA (US)

(21) Appl. No.: 14/164,071

(22) Filed: Jan. 24, 2014

(51) Int. Cl. G06F 3/041

(52) U.S. Cl. CPC G06F 3/0412; G06F 2203/04104

(57) ABSTRACT

A system, method, and computer program product are provided for sensing input stimulus at an input device. The method includes the steps of configuring an input device comprising a first sensor layer and a second sensor layer to activate the first sensor layer and to deactivate the second sensor layer, where the second sensor layer is layered above the first sensor layer and associated with a stimulus device. When a request to activate the second sensor layer is received, the input device is configured to activate the second sensor layer to respond to stimulus received by the stimulus device and to deactivate the first sensor layer. A third sensor layer may be included in the input device and the third sensor layer may be associated with a different stimulus device.

### FIELD OF THE INVENTION

The present invention relates to input devices, and more particularly to an input device using two or more stimulus sensors.

### BACKGROUND

Conventional content creation computing platforms, such as portable computing devices (e.g., laptop computers, tablet computers, and the like) are typically configured to receive input stimulus via a touch screen. The input device (e.g., touch screen), is usually provided by a resistive touch screen or a capacitive touch screen. The input stimulus may be applied by a pen, stylus, or human digit to enable a user draw or write something on the touch screen. In practice, a user's hand may also touch the screen along with the pen, stylus or user's digit. As a result, the touch screen may capture touch from the user's hand as well as from the pen, stylus, or user's digit. The touch screen may appear to the user to behave erratically when the actual response at the touch screen does not match the expected response.

The problem of capturing unintended touches by a user's hand can be partially solved using a software-based solution. For example, software may be configured to detect an area contacted by the user's palm on a touch screen that is larger than a typical touch performed by a pen, stylus, or user's digit. The software may filter the touches received at the touch screen and block any touches that contact a large area of the touch screen. However, unintended touches that contact a small area of the touch screen may not be blocked which is a shortcoming of the software-based solution. Thus, there is a need for addressing these issues and/or other issues associated with the prior art.

### SUMMARY

A system, method, and computer program product are provided for sensing input stimulus at an input device. The method includes the steps of configuring an input device comprising a first sensor layer and a second sensor layer to activate the first sensor layer and to deactivate the second sensor layer, where the second sensor layer is layered above the first sensor layer and associated with a stimulus device. When a request to activate the second sensor layer is received, the input device is configured to activate the second sensor layer to respond to stimulus received by the stimulus device and to deactivate the first sensor layer. A third sensor layer may be included in the input device and the third sensor layer may be associated with a different stimulus device.

### BRIEF DESCRIPTION OF THE DRAWINGS

FIG. 1 illustrates a flowchart of a method for sensing input stimulus at an input device, in accordance with one embodiment;

FIG. 2A illustrates a system including a dual-sensor layer input device and stimulus input devices, in accordance with one embodiment:

FIG. 2B illustrates a system including a multi-sensor layer input device and stimulus input devices, in accordance with one embodiment;

FIG. 3A illustrates a conceptual diagram of a system including a dual-sensor layer input device, in accordance with one embodiment;

FIG. 3B illustrates the display processing unit of FIG. 3A, in accordance with one embodiment;

FIG. 4 illustrates a flowchart of another method for sensing input stimulus at an input device, in accordance with one embodiment; and

FIG. 5 illustrates an exemplary system in which the various architecture and/or functionality of the various previous embodiments may be implemented.

### DETAILED DESCRIPTION

In conventional touch screen products, only one touch sensor layer (i.e., grid) is provided at the surface of a display. But usually the input methods used in touch screen are different; i.e., finger sensing or stylus. Here our idea is to provide multiple touch sensors which respond to different kind of input device on same screen. To address this problem, our solution is to provide multiple layers of touch sensors as mentioned in below diagram:

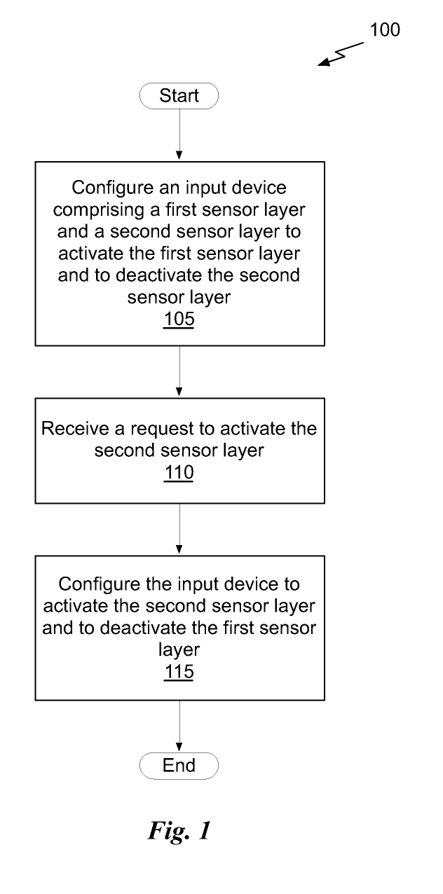

FIG. 1 illustrates a flowchart of a method 100 for sensing input stimulus at an input device, in accordance with one embodiment. At step 105, an input device comprising a first sensor layer and a second sensor layer is configured to activate the first sensor layer and to deactivate the second sensor layer, where the second sensor layer is layered above the first sensor layer and associated with a stimulus device. In the context of the present description, the input device may include two or more sensor layers comprising a touch pad or a touch screen. A touch screen integrates a display device with the input device for an intuitive user experience. In the context of the present description, a sensor layer may be configured to sense direct or indirect contact with the sensor layer. Example technologies that may be used to implement a touch-sensitive sensor layer include an electrically-resistive layer, a capacitive layer, an infrared-based detection layer, and an acoustic-based detection layer. Example technologies that may be used to implement a light-sensitive sensor layer include a solar (i.e., photovoltaic) cell-based layer.

At step 110, a request to activate the second sensor layer is received. The request to activate the second sensor layer may be received in response to activation of a stimulus device associated with the second sensor layer. In the context of the present description, a stimulus device associated with a touch-sensitive sensor layer may include a pen, stylus, or a human digit. In the context of the present description, a stimulus device associated with a light-sensitive sensor layer may include a laser pointer configured to generate a light beam at a particular wavelength. In one embodiment, the second sensor layer or the stimulus device may be activated from a user interface of an application program (e.g., a content creation program, presentation program, video game, or the like). In one embodiment, the stimulus device or the input device comprises a switch mechanism (e.g., button) that may be used to activate the stimulus device or the second sensor layer. In one embodiment, the stimulus device is activated when motion is detected (i.e., when a user picks up or otherwise repositions the stimulus device).

At step 115, the input device is configured to activate the second sensor layer to respond to stimulus received by the stimulus device and to deactivate the first sensor layer. When the first sensor layer is deactivated, stimulus received by the first sensor layer is discarded (or ignored). In general, stimulus received by an activated sensor layer is processed or responded to by the input device and stimulus received by a deactivated sensor layer is discarded or ignored by the input device.

In an example embodiment, a first sensor layer may be a touch-sensitive sensor layer configured to respond to stimulus provided by human digit input devices and a second sensor layer may be a touch-sensitive sensor layer configured to respond to stimulus provided by a stylus stimulus input device. The input device may be configured to discard stimulus applied by a human digit at the first sensor layer and to respond to stimulus applied by a stylus to the second sensor layer. Alternatively, the input device may be configured to discard stimulus applied by the stylus to the second sensor layer and respond to stimulus applied by a human digit at the first sensor layer.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

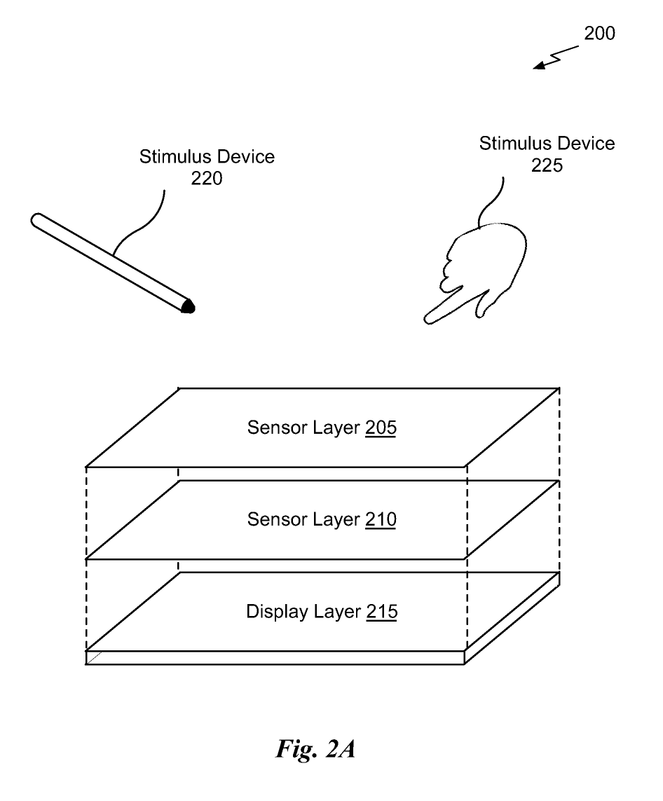

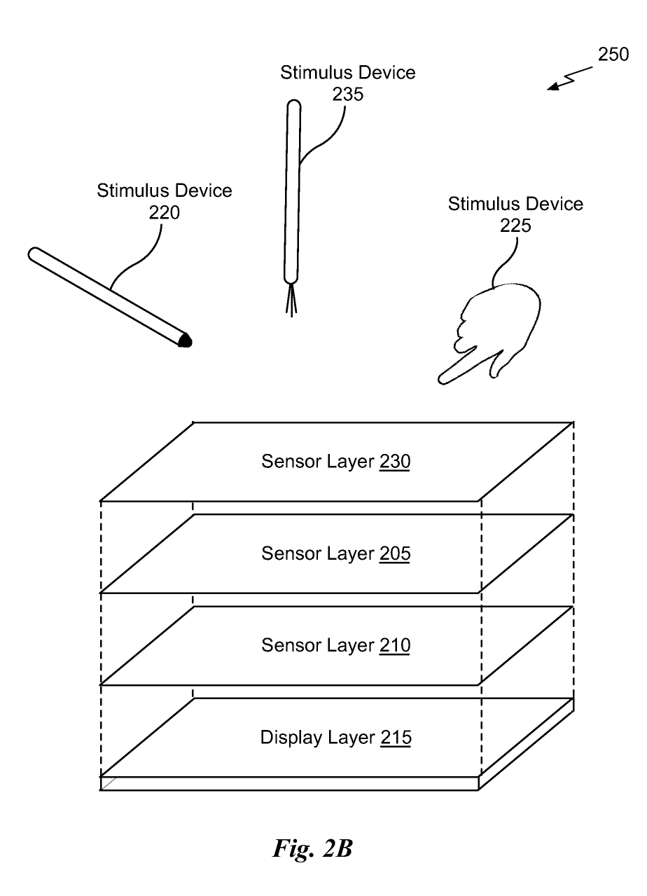

FIG. 2A illustrates a system 200 including a dual-sensor layer input device and stimulus devices 220 and 225, in accordance with one embodiment. The dual-sensor layer input device comprises the sensor layer 205 and 210. As shown in FIG. 2A, the sensor layer 205 is layered above the sensor layer 210 and the sensor layer 210 is layered above a display layer 215 to form a display device that is integrated with the dual-sensor layer input device. In one embodiment, the sensor layer 205 is layered above the sensor layer 210 and in direct contact with the sensor layer 210. Similarly, the sensor layer 210 maybe layered above the display layer 215 and in direct contact with the display layer 215. In another embodiment, the display layer 215 may be omitted and the dual-sensor layer input device may form an input pad device, such as a touchpad.

The stimulus device 220 may be a stylus stimulus input device that is associated with the sensor layer 210 and configured to provide input stimulus that is received by the sensor layer 220. The stimulus device 225 may be a user digit stimulus input device that is associated with the sensor layer 205 and configured to provide input stimulus that is received by the sensor layer 205. To avoid detection of unintended stimulus input, the system 200 includes control circuitry (not shown) that is configured to discard or ignore input stimulus received by one of the two sensor layers 205 and 210 at any particular time. Therefore, only one of the input stimulus devices 220 and 225 should be used at any particular time.

In one embodiment, the control circuitry is configured to discard stimulus input from the sensor layer 205 or 210 that is disabled. In another embodiment, the sensor layer 205 or 210 is not disabled, but signals received by the sensor layer do not result in any action taken based on the stimulus input or contribute to an image displayed at the display layer 215. In one embodiment, the sensor layer 205 may be a conventional capacitive touch-sensitive layer that is associated with the stimulus device 225 and the sensor layer 210 may be a non-capacitive sensor layer that is associated with the stimulus device 220. When the stimulus device 220 is activated, input stimulus received by the sensor layer 205 is discarded.

The sensor layer 210 may be activated when the stimulus device 220 is removed from a holder (e.g., slot) included in the system 200. In one embodiment, the sensor layer 210 is activated when a particular software application program (e.g., a content creation program) is launched by a user. As previously explained, the sensor layer 210 and sensor layer 205 may be activated through a user interface (e.g., pull-down menu, selection of an icon, or the like) or through a switch mechanism located on the input device (e.g., touchpad or touchscreen). In one embodiment, the stimulus device 220 comprises a switch mechanism that may be used to activate and deactivate the sensor layer 210.

For example, in one embodiment, the sensor layer 205 is a capacitive touch sensor and the sensor layer 210 is a touch-sensitive layer configured to only recognize stimulus input received from a stylus, such as the stimulus device 220. When a user is operating a content creation application program, the user holds the stimulus device 220 and activates the sensor layer 210 by enabling a switch on the stimulus device 220 to activate the stimulus device 220 and select a drawing tool. Stimulus input received by the sensor layer 205 is discarded by the system 200. Whenever the stimulus device 220 touches the sensor layer 210, stimulus input is processed and displayed at the display layer 215. When the user deactivates the sensor layer 210, for example by turning the switch off, the sensor layer 205 may become active and a tool, such as an eraser may be selected by default and operated by the user when the stimulus device 225 touches the sensor layer 205. While both stimulus devices 220 and 225 may be used to provide stimulus input to the input device, only one of the sensor layers is activated at a time, so that unintended stimulus input is discarded or ignored by the inactive sensor layer.

FIG. 2B illustrates a system 250 including a multi-sensor layer input device and stimulus devices 220, 225, and 235, in accordance with one embodiment. The multi-sensor layer input device comprises the sensor layers 205, 210, and 230. As shown in FIG. 2B, the sensor layer 230 is layered above the sensor layer 205, the sensor layer 205 is layered above the sensor layer 210, and the sensor layer 210 is layered above a display layer 215 to form a display device that is integrated with the multi-sensor layer input device. In one embodiment, the sensor layer 230 is layered above the sensor layer 205 and in direct contact with the sensor layer 205. In another embodiment, the display layer 215 may be omitted and the multi-sensor layer input device may form an input pad device, such as a touchpad.

The stimulus device 235 may be a light generating pointer-type device that is associated with the sensor layer 230 and configured to provide input stimulus that is received by the sensor layer 230. In contrast with the stimulus devices 220 and 225, the stimulus device 235 need not touch or otherwise contact the associated sensor layer 230 to provide stimulus input. In practice, the stimulus device 235 may be located several meters away from the sensor layer 230, such as a laser pointer device that is used to project a light point cluster onto a screen.

To avoid detection of unintended stimulus input, the system 250 includes control circuitry (not shown) that is configured to discard input stimulus received by two of the three sensor layers 205, 210, and 230 at any particular time. Therefore, only one of the input stimulus devices 220, 225, and 235 should be used at any particular time.

In one embodiment, the control circuitry is configured to discard stimulus input received by two of the three sensor layers 205, 210, and 230. In another embodiment, the two sensor layers of the three sensor layers 205, 210, and 230 are not disabled, but signals received by the two sensor layers do not result in any action taken based on the stimulus input or contribute to an image displayed at the display layer 215. In one embodiment, a priority between the three sensor layers 205, 210, and 230 is defined and signals received by the two sensor layers having lower priority compared with the sensor layer having the highest priority are discarded or the two sensor layers having lower priority are disabled. Priority levels of each sensor layer 205, 210, and 230 may be specified by an application program, set through a user interface, or be predefined for the sensor layer. In one embodiment, the sensor layer 205 may be a conventional capacitive touch-sensitive layer that is associated with the stimulus device 225, the sensor layer 210 may be a non-capacitive sensor layer that is associated with the stimulus device 220, and the sensor layer 230 may be a solar cell light-sensitive sensor layer that is associated with the stimulus device 235. When the sensor layer 210 is activated, input stimuli received by the sensor layers 205 and 235 are ignored or discarded. When the sensor layer 205 is activated, input stimuli received by the sensor layers 210 and 235 are ignored or discarded. When the sensor layer 230 is activated, input stimuli received by the sensor layers 205 and 210 are ignored or discarded.

The sensor layer 230 may be activated when the stimulus device 235 is removed from a holder (e.g., slot) included in the system 250. In one embodiment, the sensor layer 230 is activated when a particular software application program (e.g., a content creation program or presentation application program) is launched by a user. As previously explained, one or more of the sensor layers 210, 205, and/or 230 may be activated through a user interface (e.g., pull-down menu, selection of an icon, or the like) or through a switch mechanism located on the input device (e.g., touchpad or touchscreen). In one embodiment, the stimulus device 235 comprises a switch mechanism that may be used to activate and deactivate the sensor layer 230.

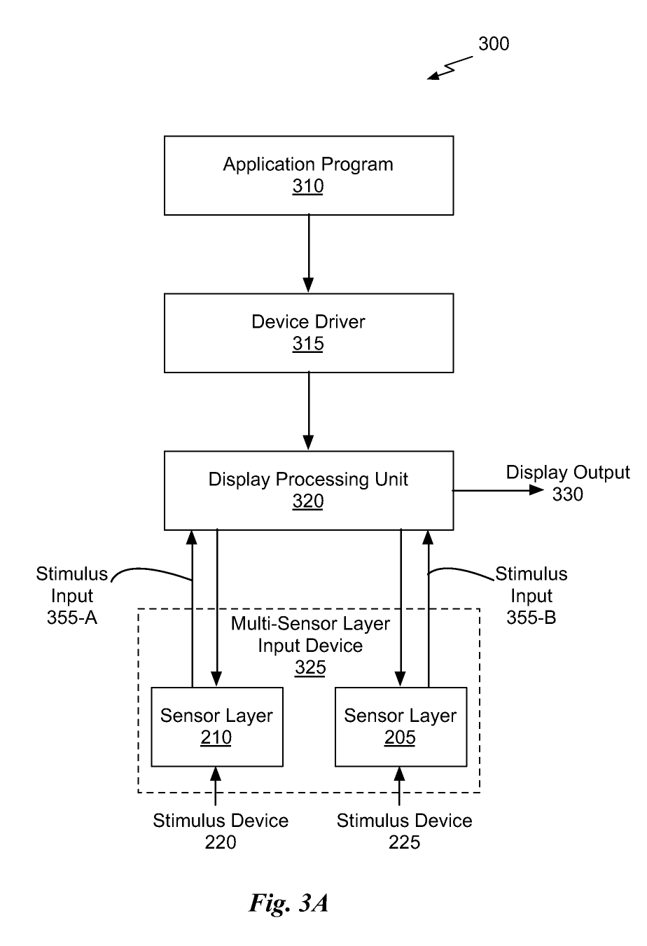

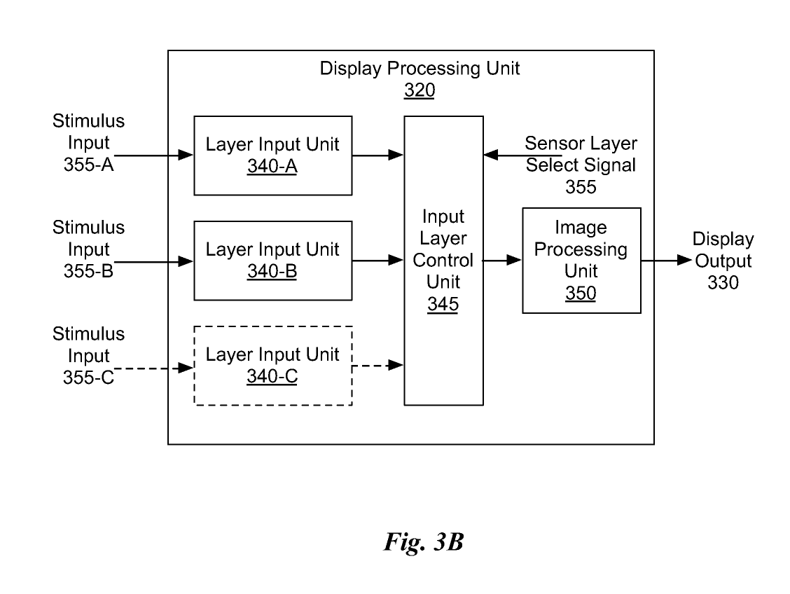

FIG. 3A illustrates a conceptual diagram of a system 300 including a multi-sensor layer input device 325, in accordance with one embodiment. The system 300 includes an application program 310, a device driver 315, a display processing unit 320, and the multi-sensor layer input device 325. An application program 310 communicates with a device driver 315 that interprets commands provided by the application program 310 and generates instructions for execution by the display processing unit 320. In one embodiment, the application program 310 may provide a user interface that enables a use to activate and deactivate the sensor layer 205 and/or 210. In one embodiment, the application program 310 may be configured to activate and deactivate the sensor layer 205 and/or 210 based on a tool that is selected by a user or may activate and deactivate the sensor layer 205 and/or 210 when the application program 310 is launched.

The display processing unit 320 is configured to provide a display output 330 that may include image data to a display device. The display processing unit 320 is coupled to multi-sensor layer device 325 that is configured to provide stimulus input 355-B to the display processing unit 320. When the stimulus device 225 is activated, the display processing unit 320 may combine the stimulus input 355-B that is received by the sensor layer 205 with other image data to produce an image for display on the display device while ignoring the stimulus input 355-A. When the sensor layer 205 is activated, the display processing unit 320 may combine the stimulus input 355-A that is received by the sensor layer 210 with other image data to produce an image for display on the display device while ignoring the stimulus input 355-B. The display processing unit 320 may disable one of the sensor layers 205 and 210 in the multi-sensor layer input device 325 based on commands received via the device driver 315 from the application program 310. The display processing unit 320 may disable one of the sensor layers 205 and 210 in the multi-sensor layer input device 325 based on an indication that one of the sensor layers 205 and 210 is activated received via the respective sensor layer 205 or 210.

In one embodiment, the display processing unit 320 is a graphics processing unit (GPU) included in a computer system such as a desktop computer system, a laptop computer system, a tablet device, and the like. The GPU may be configured to render graphics data, such as data that represents a 3D model of a scene, to generate images for display on the display layer 215 or a display device. The GPU may also be coupled to a host processor such as a central processing unit (CPU). The CPU may execute a device driver for the GPU that enables an application program 310 to provide a graphical user interface for a user to activate and deactivate the sensor layer 205 and 210.

In an alternative embodiment, the input device may be coupled to a system bus and stimulus input from the input device may be processed by an operating system on a CPU. The stimulus input may then be processed by the application program 310 and/or device driver 315 to modify commands sent to the display processing unit 320 and thereby affect an image generated for display on the display device. The architectures set forth herein are for example only and any architecture including the input device is within the scope of the present disclosure.

FIG. 3B illustrates the display processing unit 320 of FIG. 3A, in accordance with one embodiment. The display processing unit 320 includes circuit implementations of an image processing unit 350, an input layer control unit 345, and two or more layer input units 340. The image processing unit 350 generates the display out 330 that may encode one or more images for display. As previously explained, the image processing unit 350 may combine rendered image data (not shown) with input device data for the activated stimulus device provided by the input layer control unit 345. A sensor layer select signal 355 may be provided to the input layer control unit 345 in response to a user enabling or disabling a switch mechanism, interacting with a user interface to activate or deactivate a stimulus device 220, 225, or 235, or launching the application program 310.

The input layer control unit 345 receives input device data from two or more layer input units 340. In one embodiment, two or more layer input units 340 are included in the display processing unit 320, where each layer input unit 340 corresponds to a separate sensor layer. For example, the layer input unit 340-A may correspond to one of the sensor layers 205, 210, and 230 and the stimulus input 355-A may be received from one of the stimulus devices 225, 220, and 235, respectively. Similarly, the layer input unit 340-B may correspond to one of the sensor layers 205, 210, and 230 and the stimulus input 355-B may be received from one of the stimulus devices 225, 220, and 235, respectively. The optional layer input unit 340-C may correspond to one of the sensor layers 205, 210, and 230 and the stimulus input 355-C may be received from one of the stimulus devices 225, 220, and 235, respectively.

In one embodiment, the input layer control unit 345 is configured to disable layer input units 340 corresponding to sensor layers that are not activated so that the disabled layer input units 340 do not provide input device data to the input layer control unit 345. The input layer control unit 345 may be configured to disable one or more of the layer input units 340 based on priority levels associated with the sensor layers. In another embodiment, the input layer control unit 345 receives input device data from one or more of the layer input units 340 and discards the input device data from layer input units 340 that correspond to sensor layers that are not activated. The input layer control unit 345 may be configured to discard the input device data from one or more of the layer input units 340 based on priority levels associated with the sensor layers.

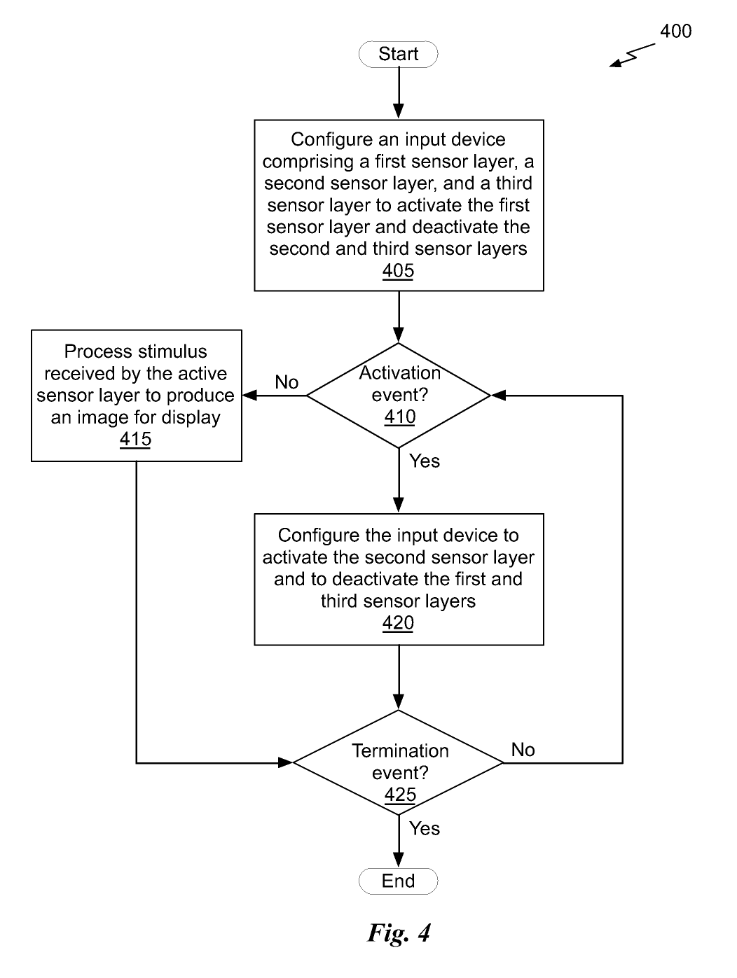

FIG. 4 illustrates a flowchart of another method 400 for sensing input stimulus at an input device, in accordance with one embodiment. Although method 400 is described in the context of certain circuit and system implementations described in FIGS. 2A, 2B, 3A, and 3B, the method 400 may also be performed by a program, other custom circuitry, or by a combination of custom circuitry and a program. Furthermore, persons of ordinary skill in the art will understand that any system that performs method 400 is within the scope and spirit of embodiments of the present invention.

At step 405, the input layer control unit 345 configures an input device comprising a first sensor layer, a second sensor layer, and a third sensor layer to respond to stimulus received by the first sensor layer and to discard stimulus received by the second sensor layer and the third sensor layer. At step 410, the input layer control unit 345 determines if an activation event has occurred. In one embodiment, an activation event occurs when an inactive (i.e., deactivated) sensor layer is activated. In one embodiment, an activation event occurs when a stimulus device associated with an inactive sensor layer is activated. A sensor layer and/or stimulus device may be activated from a user interface of an application program or by a switch mechanism. A stimulus device may be activated when movement of the stimulus device is detected.

If, at step 410, the input layer control unit 345 determines that an activation event has not occurred, then at step 415, the input layer control unit 345 provides stimulus received by the active sensor layer to the image processing unit 350. The image processing unit 350 is configured to produces an image for display at a display layer and output the image via display output 330.

If, at step 410, the input layer control unit 345 determines that an activation event has occurred, then, at step 420, the input layer control unit 345 configures the input device to activate the second sensor layer and to deactivate the first sensor layer and the third sensor layers. When the second sensor layer is activated, the input device responds to stimulus received by the second sensor layer. When the first sensor layer and third sensor layer are deactivated, the input device discards stimulus received by the first sensor layer and the third sensor layer, respectively. At step 425, the input layer control unit 345 determines if a termination event has occurred. A termination event may occur when the input device is disabled (e.g., powered down or shut down) or when an activated stimulus device has been idle for a period of time. If, at step 425, the input layer control unit 345 determines that a termination event has occurred, then the method 400 terminates. Otherwise, the input layer control unit 345 returns to step 410.

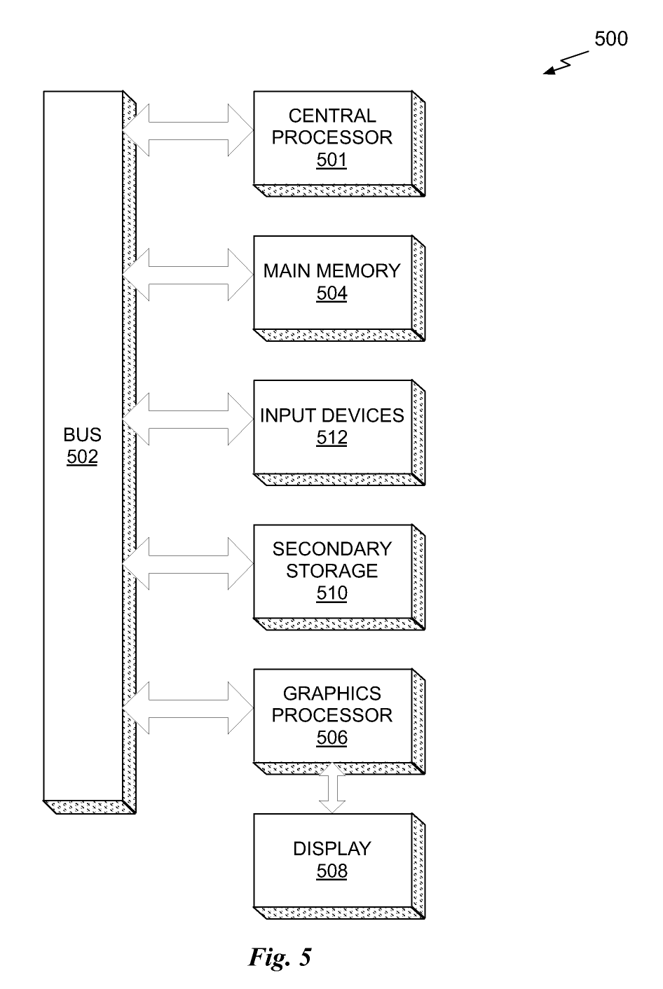

FIG. 5 illustrates an exemplary system 500 in which the various architecture and/or functionality of the various previous embodiments may be implemented. As shown, a system 500 is provided including at least one central processor 501 that is connected to a communication bus 502. The communication bus 502 may be implemented using any suitable protocol, such as PCI (Peripheral Component Interconnect), PCI-Express, AGP (Accelerated Graphics Port), HyperTransport, or any other bus or point-to-point communication protocol(s). The system 500 also includes a main memory 504. Control logic (software) and data are stored in the main memory 504 which may take the form of random access memory (RAM).

The system 500 also includes input devices 512, a graphics processor 506, and a display 508, i.e. a conventional CRT (cathode ray tube), LCD (liquid crystal display), LED (light emitting diode), plasma display or the like. User input may be received from the input devices 512, e.g., keyboard, mouse, touchpad, microphone, and the like. In one embodiment, the display 508 may be a touchscreen or other display device including one or more sensor layers, and stimulus input devices may be associated with one or more of the sensor layers.

In one embodiment, the graphics processor 506 may include a plurality of shader modules, a rasterization module, etc. Each of the foregoing modules may even be situated on a single semiconductor platform to form a graphics processing unit (GPU). When the input devices 512 comprises a touchpad or other input device including one or more sensor layers, stimulus input devices may be associated with one or more of the sensor layers. The graphics processor 506 or central processor 501 may be configured to receive stimulus input receives by the one or more sensor layers and process the stimulus input to produce an image for display by the display 508.

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 500 may also include a secondary storage 510. The secondary storage 510 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 504 and/or the secondary storage 510. Such computer programs, when executed, enable the system 500 to perform various functions. The memory 504, the storage 510, and/or any other storage are possible examples of computer-readable media.

In one embodiment, the architecture and/or functionality of the various previous figures may be implemented in the context of the central processor 501, the graphics processor 506, an integrated circuit (not shown) that is capable of at least a portion of the capabilities of both the central processor 501 and the graphics processor 506, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 500 may take the form of a desktop computer, laptop computer, server, workstation, game consoles, embedded system, and/or any other type of logic. Still yet, the system 500 may take the form of various other devices including, but not limited to a personal digital assistant (PDA) device, a mobile phone device, a television, etc.

Further, while not shown, the system 500 may be coupled to a network (e.g., a telecommunications network, local area network (LAN), wireless network, wide area network (WAN) such as the Internet, peer-to-peer network, cable network, or the like) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method comprising:
configuring an input device comprising a first sensor layer and a second sensor layer to activate the first sensor layer and to deactivate the second sensor layer, wherein the second sensor layer is layered above the first sensor layer and associated with a stimulus device;
receiving a request to activate the second sensor layer; and
configuring the input device to activate the second sensor layer to respond to stimulus received by the stimulus device and to deactivate the first sensor layer.

2. The method of claim 1, wherein the first sensor layer comprises a touch-sensitive sensor layer.

3. The method of claim 2, wherein the second sensor layer comprises a second touch-sensitive sensor layer.

4. The method of claim 2, wherein the second sensor layer comprises a light-sensitive sensor layer.

5. The method of claim 1, wherein the first sensor layer comprises a light-sensitive sensor layer.

6. The method of claim 5, wherein the second sensor layer comprises a touch-sensitive sensor layer.

7. The method of claim 1, wherein the request is generated by an application program based on user interface input.

8. The method of claim 1, wherein the request is generated in response to activation of the stimulus device associated with the second sensor layer.

9. The method of claim 1, wherein the request is generated by a switch mechanism.

10. The method of claim 1, wherein the first sensor layer is layered above a display layer to form a display device.

11. The method of claim 1, wherein the input device responds to stimulus received by the first sensor layer and discards stimulus received by the second sensor layer when the first sensor layer is activated and the second sensor layer is deactivated.

12. The method of claim 1, wherein the stimulus received by the second sensor layer is applied by a digit.

13. The method of claim 1, wherein the stimulus received by the second sensor layer is applied by a stylus.

14. The method of claim 1, wherein the stimulus received by the second sensor layer is applied by a light generating pointer-type device.

15. The method of claim 1, further comprising a third sensor layer that is layered above the second sensor layer and associated with a different stimulus device.

16. A non-transitory computer-readable storage medium storing instructions that, when executed by a processor, cause the processor to perform steps comprising
configuring an input device comprising a first sensor layer and a second sensor layer to activate the first sensor layer and to deactivate the second sensor layer, wherein the second sensor layer is layered above the first sensor layer and associated with a stimulus device;
receiving a request to activate the second sensor layer; and
configuring the input device to activate the second sensor layer to respond to stimulus received by the stimulus device and to deactivate the first sensor layer.

17. An input device, comprising:
a first sensor layer;
a second sensor layer that is layered above the first sensor layer and associated with a stimulus device; and
a control unit configured to:
activate the first sensor layer and to deactivate the second sensor layer;
receive a request to activate the second sensor layer; and
activate the second sensor layer to respond to stimulus received by the stimulus device and deactivate the first sensor layer.

18. The input device of claim 17, wherein the first sensor layer comprises a touch-sensitive sensor layer.

19. The input device of claim 18, wherein the second sensor layer comprises a second touch-sensitive sensor layer.

20. The input device of claim 18, wherein the second sensor layer comprises a light-sensitive sensor layer.
